(19) United States
(12) Patent Application Publication
(10) Pub. No.: US 2019/0163153 A1
(43) Pub. Date: May 30, 2019

(54) ENFORCING DYNAMIC VOLUME THRESHOLDS OF AN ENTERTAINMENT DEVICE

(71) Applicant: International Business Machines Corporation, Armonk, NY (US)

(72) Inventors: Dana L. Price, Surf City, NC (US); Shelbee Smith-Eigenbrode, Thornton, CO (US); Aaron J. Quirk, Raleigh, NC (US); Lisa Seacat DeLuca, Baltimore, MD (US)

(21) Appl. No.: 15/827,237

(22) Filed: Nov. 30, 2017

(51) Int. Cl. G05B 19/045; G05B 19/05; G05B 19/408; G05B 15/02

(52) U.S. Cl. CPC G05B 19/045; G05B 19/054; G05B 2219/2615; G05B 15/02; G05B 19/4083

(57) ABSTRACT

Machine logic (for example, software) for managing the nuisance level characteristic (for example, nuisance-level sound) of another user's electronic, media-connected device. The machine logic considers contextual information (such as where the user is presently located and whether it is appropriate for the user's device to be emanating a loud, nuisance level volume).

### BACKGROUND

The present invention relates generally to the field of software for determining the volumes of computer-based sound systems. brightness levels of computer displays and other similar settings of computer devices when the setting can affect a degree to which people in the vicinity of the device are annoyed or bothered by output of the computer device.

US patent application 2016/0231718 (“Logan”) states as follows: “A method of setting preferences in an intelligent device is described where the intelligent device searches a context for other devices and then exchanges preference tables with the other devices. The intelligent device executes a negotiation algorithm on the set of preference tables and sets a parameter based on the outcome of the negotiation. The negotiation algorithm could be one of a voting algorithm, a weighted voting algorithm, a last (or first) one in algorithm, a bidding algorithm, an averaging algorithm, a priority algorithm, a matching algorithm, or a sharing algorithm. The parameter can impact . . . the behavior of the intelligent device itself, [or] the environment . . . Independently or in conjunction with the above algorithms is a priority algorithm that allows certain individuals to set their preferences over the preferences of others. For instance, in a preference scenario for a church, the phone ring preferences for all phones could be set to silent upon entering the sanctuary. But a doctor could override that preference so that they are always able to receive an emergency call.”

### SUMMARY

According to an aspect of the present invention, there is a method, computer program product and/or system that performs the following operations (not necessarily in the following order): (i) receiving a set of request(s), respectively from a set of requesting device(s) respectively controlled by a set of requesting user(s), with each request of the set of request(s) including information indicative of a desire that a nuisance-causing characteristic of a target device, controlled by a target user, be decreased by respective requested amounts of decrease; (ii) receiving a contextual data set including information of a set of attribute(s) relating to a context in which the target device is exhibiting the nuisance-causing characteristic; (iii) responsive to the receipt of the set of request(s), applying a set of machine logic based rules to determine a negotiated compromise amount of decrease based upon the contextual data set, where the amount of decrease is: (a) greater than zero, and (b) less than at least some of the request amount(s) of decrease; and (iv) decreasing, by machine logic, the nuisance-causing characteristic of the target device by negotiated compromise amount of decrease.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system; and

FIG. 5 is a user environment diagram showing information that is helpful in understanding embodiments of the present invention.

### DETAILED DESCRIPTION

Some embodiments of the present invention are directed to machine logic (for example, software) for managing the nuisance level characteristic (see Definitions sub-section, below for definition of “nuisance level characteristic”) of another user's electronic, media-connected device. In some embodiments, the machine logic considers contextual information (such as where the user is presently located and whether it is appropriate for the user's device to be emanating a loud, nuisance level volume). This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

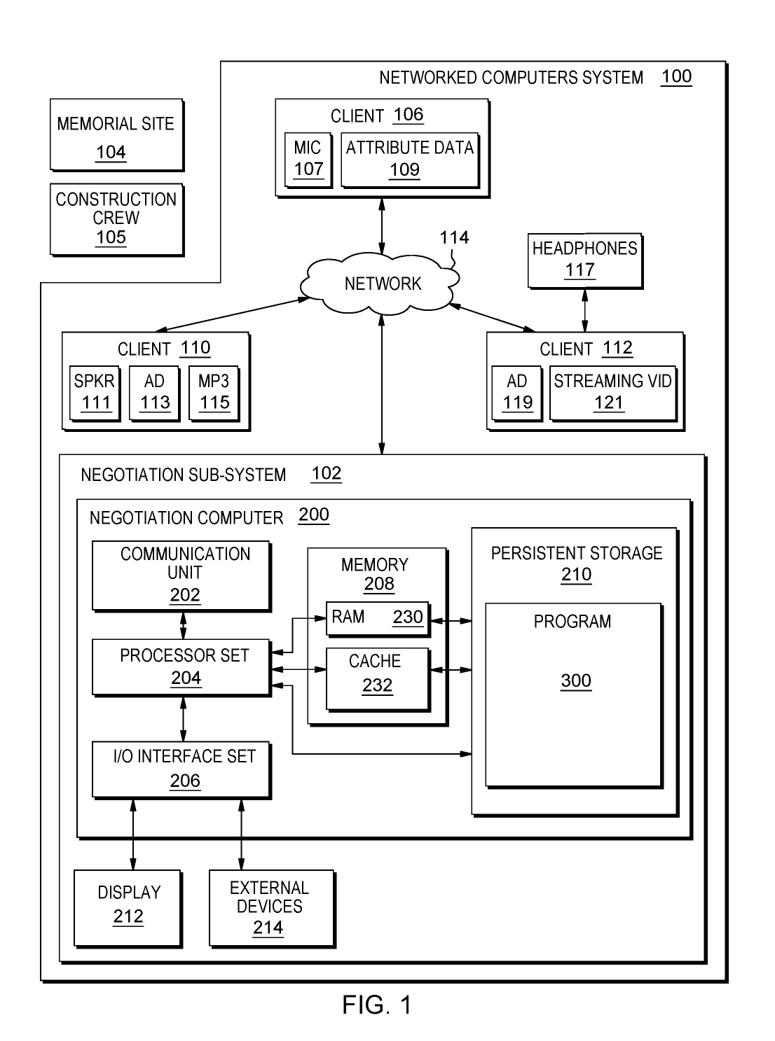

An embodiment of a possible hardware and software environment for software and/or methods according to the present invention will now be described in detail with reference to the Figures. FIG. 1 is a functional block diagram illustrating various portions of networked computers system 100, including: negotiation sub-system 102; memorial site 104, construction crew 105, client 106, client 110, client 112, headphones 117; communication network 114; negotiation computer 200; communication unit 202; processor set 204; input/output (I/O) interface set 206; memory device 208; persistent storage device 210; display device 212; external device set 214; random access memory (RAM) devices 230; cache memory device 232; and program 300. Further, client 106 includes microphone (“mic”) 107, attribute data (“AD”) 109; client 110 includes speaker 111, attribute data 113, MP3 player 115; client 112 includes attribute data 119, streaming video 121, and is operationally connected to headphones 117.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

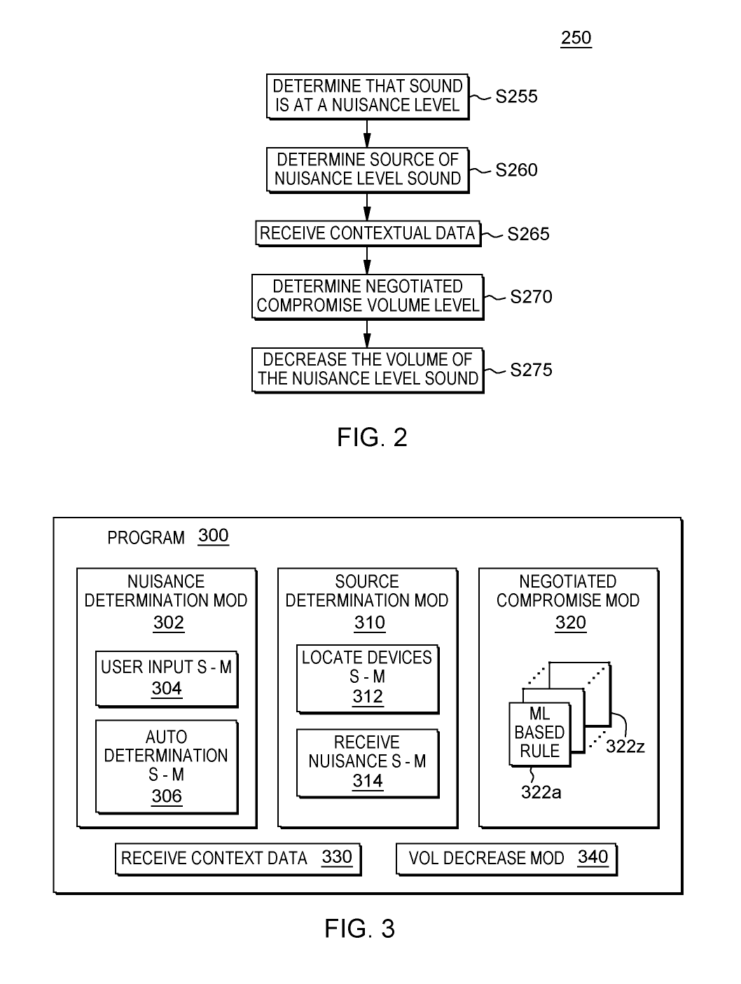

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation 5255, where: (i) microphone 107 of client device 106 (see FIG. 1) receives some high volume sound waves, (ii) client device 106 sends the detected volume level, through communication network 114, to auto-determination sub-module 306 of nuisance determination module 302 of program 300 of negotiation computer 200 (see FIG. 1); and (iii) machine logic based rules of the auto-determination sub-module determines that the volume of sound being received at client device 106 amounts to a nuisance (see definition of “nuisance-causing characteristic,” below in the DEFINITIONS sub-section of this document). In this embodiment, the machine logic based rules for determining a nuisance are based on a fixed and constant decibel level threshold. Alternatively, the nuisance determining rules may be more complex, varying the decibel threshold and/or considering factors like time of day, geographical locations, estimates of distance between the client device and the producer of the sound being detected, etc.

Alternatively, the user of client device 106 may manually input that a nuisance level sound is being experienced, and this user input would be registered a nuisance level sound by user input sub-module 304 of nuisance determination mod 302.

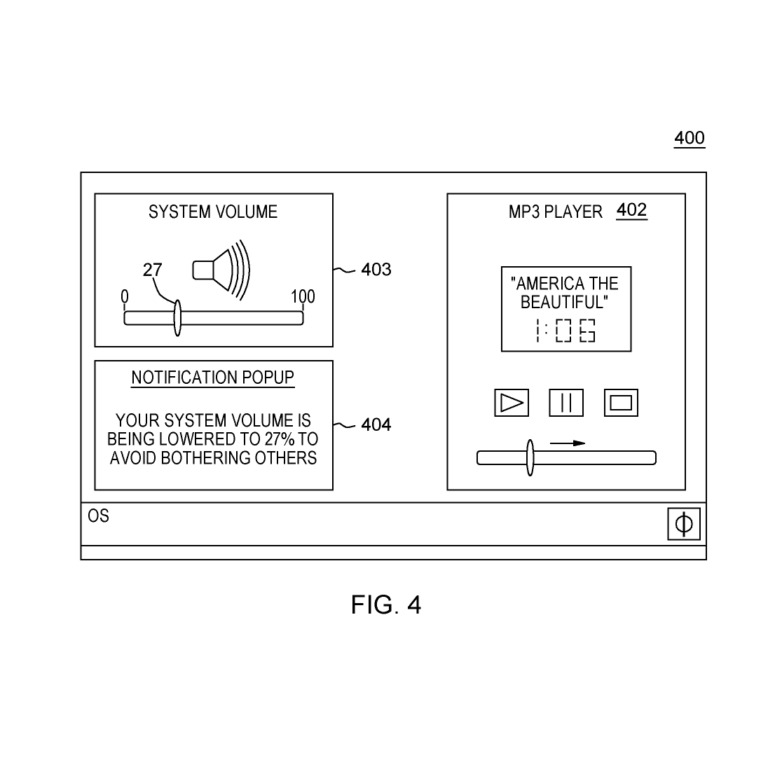

Processing proceeds to operation 5260, where source determination mod 310 determines the source of the nuisance level sound. In this example, there are several possibilities as far as possible sources of the nuisance level sound: (i) construction crew 105 working with power tools (not shown) on memorial site 104; (ii) client device 112, which is playing a streaming video of a horror movie that is cranked all the way up; and (iii) client device 110, which is playing “America The Beautiful” on an mp3 player at 50% volume (see MP3 player user interface 402 in screenshot 400 of FIG. 4).

More specifically, in this example, receive nuisance sub-module 314 of source determination mod 310 receives a sample of the sound being received by microphone 107 of client device 106 (see FIG. 1). Source determination mod 310 analyzes the sound sample to determine that it is the song “America The Beautiful.” Locate devices sub-module 312 of source determination mod 310 polls all registered devices in proximity to GPS (Global Positioning System) co-ordinates of client device 106 to determine what media they are playing. During this polling: (i) attribute data 113 of registered client device 110 communicates to source determination mod 310 that device 110 is currently playing an MP3 file of the song “America the Beautiful” on an MP3 player 115 that has its volume set at 50% of maximum; and (ii) attribute data 119 of registered client device 112 communicates to source determination mod 310 that device 112 is currently playing a streaming horror movie called “Caught In the Sensitive Word Filter” on streaming video player 121 that has its volume set at 100% of maximum. It is noted that the construction crew is a group of people with power tools (which are not intelligent tools that can communicate data over communication networks), so it is fortunate that the construction crew is not the source of the nuisance sound level here, because nothing could be done about it. Of course, source determination mod 310 detects the match between the detection of “America The Beautiful” as the offending noise (or sound) and client device 110 as the device likely causing the nuisance experienced by client device 106. This makes sense here because (unbeknownst to negotiation computer 200) client device 112 is using headphones 117 to prevent causing a nuisance, while client device 110 has powerful built in speaker 111 that is rattling the entire memorial site, even at half volume.

In this embodiment GPS coordinates are used to determine proximity of devices and/or users of devices. Alternatively, beacons, cellular triangulation, WiFi triangulation, any new types of location methods, etc. can be used for this purpose.

Processing proceeds to operation 5265, where receive contextual data mod 330 receives contextual data. More specifically, the receive contextual data mod receives various kinds of contextual information from: (i) attribute data store 109 of client device 106; and (ii) attribute data store 113 of client device 110.

In this example, the context data includes the following types: (i) attributes of the people involved in the nuisance situation (including attributes of the user of the device detecting the nuisance, attributes of the user of the device generating the detected nuisance, and attributes of other registered users known to be in physical proximity (for example, children versus seniors versus young adults)); (ii) attributes of the devices involved in the nuisance situation (including attributes of the device detecting the nuisance, attributes of the device generating the detected nuisance and attributes of other devices known to be in physical proximity); (iii) the content of the sound creating the nuisance (for example, public service announcement, political speech, song, movie, random noises, ringtone, lewd sounds); (iv) frequency(ies) of the sound creating the nuisance (for example, frequencies that cause brain trauma, frequencies that cause digestive system disturbance, pleasant frequencies, frequencies that carry a long versus short distance); (v) local ambient conditions (for example, local weather, local ambient noise levels); (vi) zoning type information (for example, urban, rural, suburban, sacred place (for example, cathedral, memorial site), proximity to a busy roadway); (vii) cultural context or event (for example, rock concert, fireworks show, patriotic holiday, Octoberfest, funeral, wedding); (viii) time of day; (ix) time of year; and/or (x) how sound is created (for example, through headphones, from automobile speakers, from speakers built into a stadium sound system).

Processing proceeds to operation 5270, where machine logic based rules 322a to 322z of negotiated compromise mod 320 determine a negotiated compromise volume level for the system volume level (see FIG. 4 at system volume control window 403) of client device 110. The meaning of “compromise” will now be explained. In a “negotiated compromise” (as that term is used herein) an amount of decrease of a nuisance-causing characteristic is based upon context information and the amount of change in the nuisance causing characteristic is: (i) greater than zero (that is, there is some change from the status quo), and (ii) less than the complaining device would like to have happen. For example, in a loud volume nuisance context, a complaining device is presumed to want the volume of the complained about device to be turned all the way down to zero volume. However, in a “negotiated compromise” the volume is not turned all the way down, but, rather, it is turned to an intermediate volume that is somewhere between the volume at the time of the nuisance complaint and zero volume. This is what distinguishes a “negotiated compromise” from other types of negotiation where a device either turns down all the way, or, depending upon the algorithm and input data of the negotiation, allowed to keep its volume all the way up.

In this example, one machine logic rule (322a to 322z) of negotiated compromise mod 320 dictates that an initial compromise volume for client device 110 will be halfway between the current system volume of client device 110 and zero volume. In this example, the system volume of client device 110 is 50% at the time that mods 302 and 310 determine that client device 110 is outputting sound at a nuisance level. This means that the initial compromise here is a system volume level of 25% because that is halfway between the current system volume level of 50% and 0%. Alternatively or additionally, other volume attributes of client device 110 could be subject to compromise, such as: (i) changing the volume control built into MP3 player 115, and/or (ii) changing the volume only of the bass frequencies of the system volume of client device 110.

After the initial compromise volume setting is determined, context data is applied to other machine logic rules 322 of negotiated compromise mod 320 in order to adjust the initial compromise volume up and/or down depending upon relevant pieces of context that would suggest higher/lower permissible volumes in current context. A couple of examples will be discussed in the next couple of paragraphs.

One machine logic rule 322 dictates that if the sound level nuisance is in proximity to a memorial site, then the volume should be turned down an extra 10%. After application of this machine logic rule, the tentative compromise system volume of client device 110 would be 20% because: (i) the devices are in proximity to memorial site 104 (see FIG. 1); (ii) 10% of the distance between zero volume and the current 50% volume level of client device 110 is 5% in system volume terms; and (iii) 20% is the result when 5% is knocked off of the initial compromise value of 25%.

Another machine logic rule dictates that if the sound nuisance is a patriotic song being played on a patriotic holiday then the volume can go up by 20%. In this example, the song is “America The Beautiful,” which is a patriotic song, and the date is Remembrance Day, which is a patriotic holiday, meaning that the compromise system volume of device 110 can be bumped back up to 30% (that is, 20% system volume plus 20% adder of 50% basis).

One final machine logic rule will be applied in this example. This one works a little differently in that there is not a percentage adder/subtracter applied on a basis of the distance between current system volume and a zero volume (which is the way the previous two machine logic based rules worked). Rather, this rule is a multiplier type rule. More specifically, this rule dictates that if the sound nuisance is being produced by a powerful built-in speaker (like speaker 111 of device 110), then the compromise volume is multiplied by a factor of 0.9. In this case, the current compromise volume is 30%. 30%*0.9=27%, so the final compromise system volume value is 27% in this example.

Processing proceeds to operation 5275, where volume decrease mod 340 decreases the volume of system volume level of client device 110 from 50% of maximum system volume to 27% of maximum system volume. This is shown at system volume user interface window 403 and notification popup 404 of screenshot 400 of FIG. 4. This information is displayed on client device 110 so that the user of client device 110 is not confused about why her system volume is going down. In this example, negotiation sub-system also places a ten minute one way lock on the system volume of client device 110 to prevent the user of client device 110 from turning the system volume back up above 27%.

It is noted that, because this embodiment reaches a context-sensitive “compromise” solution, no user in vicinity of memorial site 104 will necessarily be completely satisfied—unlike other negotiation systems where volume is either fully maintained or completely turned down. For example, there may be others at the memorial site who really want to hear “America The Beautiful” played on Remembrance Day. These people can move closer to the powerful built-in speaker of client device 110 to commune with each and with the tune in remembrance of fallen soldiers who have made the ultimate sacrifice for their home nation. On the other hand, the user of client device 106 prefers quieter reflection, and, while she is not getting silence out of the compromise solution, she is getting significantly decreased sounds, and can probably get pretty close to silence by moving away from client device 110 now that it is only playing at 27% of maximum system volume. The compromise solution may or may not maximize aggregate satisfaction of all present at the memorial site, but it provides for a fair and equitable distribution of satisfaction, which may well be the optimum result when it comes to computer device nuisances like sound volume and display brightness.

In some embodiments, each of the devices need to opt in to participate in the nuisance control system. In other embodiments, for example electronic devices issued in schools or prisons, an opt in may not be needed or preferred. However, an “opt-in” system can lead to solutions that are not only fair and equitable, but also acceptable to all parties.

### III. Further Comments and/or Embodiments

Some embodiments of the present invention recognize the following facts, potential problems and/or potential areas for improvement with respect to the current state of the art: (i) many entertainment devices are now being connected to local computer networks and the internet, thereby allowing a greater deal of remote control of user devices; (ii) one such area that allows for remote control of user devices is the volume of an entertainment device, such as a television, DVD player, stereo or even a mobile device's external speaker; (iii) there are already existing ways to remotely control the volume of various media devices, but these ways of remote control are based on: (a) manual control of the media devices, (b) the media devices are reactive to a command, and/or (c) an event or timing mechanisms control the media devices; and/or (iv) what is lacking in the art is a more dynamic way to control volume thresholds of the media devices based on the relationships of people in the vicinity of the entertainment device.

A hypothetical story that may be helpful in understanding some embodiments of the present invention will now be set forth. There are often a variety of distracting or bothersome noises around us. For example, when staying at a hotel, the TV in a neighboring room may be excessively loud and may prevent a person from getting much needed sleep. In this hypothetical story, a person watching TV (user A) is completely unaware that user A is bothering somebody (user B) across the thin wall. User A would gladly turn down the volume if user A knew that there was a problem. In another similar hypothetical story, user C assumes that watching a movie in the basement is not bothering anyone at all, but it is bothering somebody (user D) who is trying to study in a room upstairs. In both of these hypothetical stories, the sound level of user A's, or user C's, device might be just fine, up until the point that another user needs to sleep/study/etc.

Some embodiments of the present invention may include one, or more, of the following features, characteristics and/or advantages: (i) enables a person's mobile device to act as a sensor to determine the impact of a noise source at a given location; and/or (ii) based on preferences of the target user, a request to reduce volume such that the user's audio threshold is satisfied may be dynamically made to the audio source.

A method for use with a wireless device and a volume-control device that controls the volume of an audio signal includes the following operations (not necessarily in the following order): (i) receiving, a request (including a first priority value) from the wireless device, with the request including information indicative that a user of the wireless device would prefer to have volume of the audio signal decreased; (ii) determining, by a machine logic negotiation, that the volume-control device should decrease the volume based on at least one of the following factors: (a) current volume level of the audio signal, (b) situation, (c) scheduling, (d) user patterns and/or (e) occasion; (iii) responsive to the determination, sending a signal to a volume control module of the volume-control device, with the signal indicating that the volume control module is to lower the volume of the audio signal; (iv) assigning a first priority value to the wireless device; (v) determining, by machine logic, that the first priority value exceeds a priority threshold; (vi) on condition that the first priority value exceeds the priority threshold, decreasing, by the volume-control device, the volume; (vii) assigning a second priority value to the volume control device, where the priority threshold is based upon the second priority value and the user of the wireless device is different than a primary user of the volume control device; and (viii) negotiating, using thresholds, to enforce dynamic volume thresholds of an entertainment device.

Some embodiments of the present invention may include one, or more, of the following features, characteristics and/or advantages: (i) one of the devices imposes a volume threshold based on their priority in the environment; (ii) addresses the problem of having others notice or be disrupted by the volume on another user's device; (iii) solves a problem where the media devices communicate with one another to control the independent output of one of the media devices; (iv) sets a volume threshold or creates a volume preference; (v) allows for voting; (vi) dynamically imposing a volume threshold on an entertainment device; (vii) determining the dynamic volume threshold by proximity of nearby individuals and the various priorities of those nearby individuals, and the perceived volume at a given location relative to the source of the audio channel; (viii) allowing individuals to submit requests to the system to reduce volume, which can be accepted or rejected based on the user's priority in the system; (ix) determining a volume threshold based on proximity of user(s) with their unique preferences; (x) determining a volume threshold as perceived by a device at a given location; (xi) requesting the reduction of volume of an entertainment device based on the determined volume thresholds, which leads to: increased customer satisfaction, improved sleep patterns, increased privacy, reduces conflict, license value to media software vendors; (xii) improvements with respect to collaborative mobile applications that could implement embodiments of the present invention; and/or (xiii) using employers' proprietary software to implement embodiments of the present invention across a work location through control of users' (employees) media software applications.

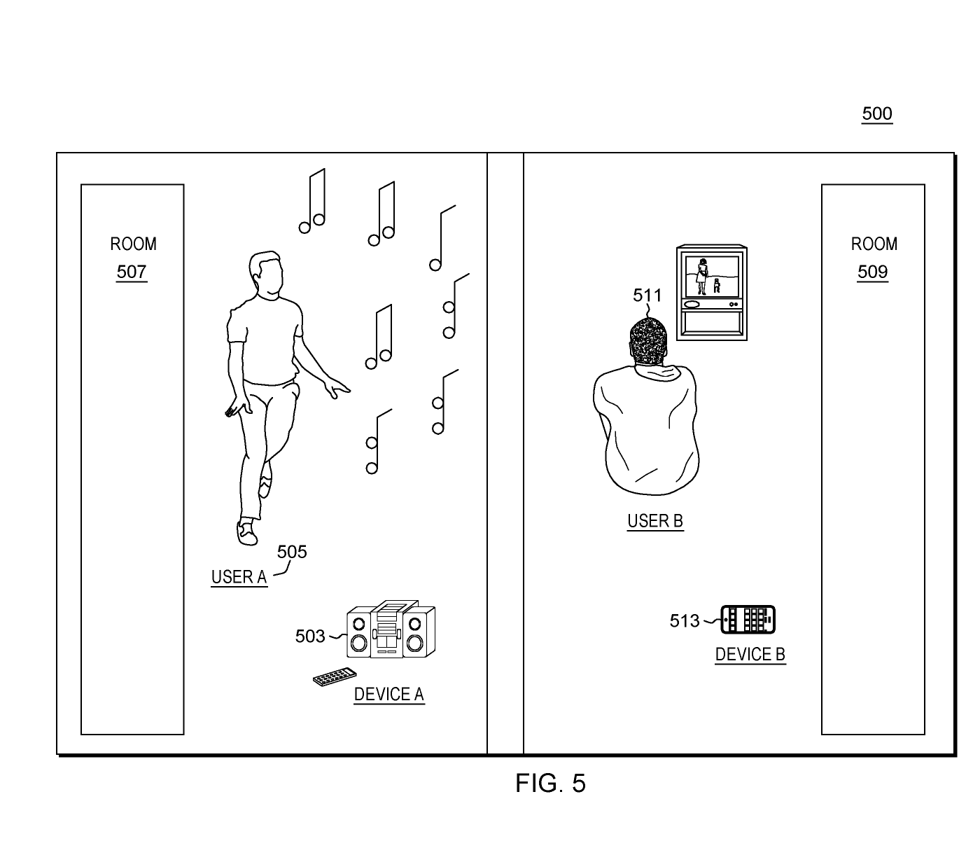

As shown in FIG. 5, user environment diagram 500 includes: room 507 and room 509. Room 507 includes: device A 503; and user A 505. Room 509 includes: device B 513; and user B 511. In user environment diagram 500, a network connected media device (such as device A) begins playing an audio stream while a given user (such as user B) is within range of the audio stream. The network on which device A plays can be any communication channel such as WiFi, TCP, Bluetooth, etc. User B's mobile device (device B) measures the perceived volume of the audio stream either automatically or upon user B's request. Device B then determines whether the perceived volume is above user B's defined threshold, with this threshold setting being based upon: (i) user B's general preference; (ii) user B's indication that the volume is “too loud” at the current time; (iii) user B's current activity that is in progress (that is, user B could be sleeping or could be on the telephone and requires a quieter environment); and/or (iv) device B learns the trends of user B's desired audio based on context. Additionally, device B identifies the content of the audio stream (for example, a sample of the identified audio stream is sent for analysis to determine a given song or a movie the audio channel belongs to).

In some embodiments, the identification of a particular song is one of many preferences that can cause user B to request a volume decrease. In some embodiments, a particular song can also be identified for the purpose of differentiating between two distinct audio streams. Additionally, the identification of a particular song can be used as an input when multicasting to devices to lower their volume (for example, “anyone playing “Turn Down for What?” . . . can you please reduce by 50%?”) in the event that there is no pre-defined list of devices/audiostreams available to choose from in order to make the volume decrease.

In some embodiments of the present invention, device B queries local network channels (not shown) for a device currently playing the identified audio track. All devices (including device A and device B) that are connected to this network will receive a query. In some embodiments of the present invention, device A (that is, connected to the network) acknowledges that it is currently playing the identified audio track. Device B receives acknowledgment that device A is currently playing the identified audio track. At this point, device B: (i) identifies itself to device A; and (ii) requests a decrement in volume. This decrement request may have an integer value to request how much volume (that is, the percentage level indication of the volume or the decibel value) is desired to be reduced. Optionally, user B can specify to approve/reject the decrement request prior to sending to media device A. In some embodiments, Device B sends its request for: (i) a volume decrease, (ii) user identification, or (iii) other contextual information about Device B and/or User B.

Device A then either accepts or rejects the decrement request based on at least one of the following: (i) configuration of device A; (ii) priority of the individual (for example, user B) requesting the decrease in volume; (iii) location of the individual (for example, if user B is at a hotel, then he or she is inclined to always accept the volume decrement request, but if user B is at home, then he or she is inclined to never accept the volume decrement request); (iv) number of volume decrement request(s) received (for example, if one request is received by a user, this may indicate that the requesting user is simply a cranky neighbor; however, if three or more requests from different devices/users are received, this may indicate that it is time to accept the volume decrement request and lower the volume); and/or (v) connected network (for example, if user A is on a telephone call on his car's Bluetooth system and a volume decrease request is received, user A should always accept because user A does not want those outside the car to hear the mobile call). Upon accepting or rejecting the volume decrement request, device A notifies device B if volume has been decreased. Upon user A rejecting the volume decrement request, user B is notified that the volume will not be reduced from user A's device A (that is, user B is not able to leverage embodiments of the invention further). Upon accepting the volume decrement request, user B is notified of success (that is, user B will be notified that user A has agreed to lower the volume level of his or her device A).

In some embodiments of the present invention, the volume is incrementally reduced by device A and measured by device B until the volume level has reached a satisfactory level (that is, the volume level is such that sending a volume decrement request is not likely to be needed). Additionally, it is also important to consider that the media device A may accept another device's initial request(s) for the volume to be reduced, but may deny requests depending on a lower bound threshold configured on the device A.

To highlight the importance of priority, consider the following example: a parent and child may both have devices that can communicate with the same stereo system. If the parent is listening to the stereo, the parent may allow for some variation in volume as desired by the child. However, if the child is listening to the stereo, the parent may configure the system to give their device complete control over the perceived volume. In the same way, the volume thresholds can be configured “middle of the road” for public environments such as hotels or transportation where there is no clear “owner” of the device or service. The volume of the network connected media devices (devices A and B) could also be adjusted based on how close the first user is to the second user. As the second user moves further away from the first user, the volume doesn't sound as loud as it would if they were standing right next to each other. Therefore, distance can be used to automatically lower or increase the volume based on the preferences (as described above with respect to some embodiments of the present invention).

Some embodiments of the present invention may include one, or more, of the following features, characteristics and/or advantages: (i) using a wireless device and a volume-control device that controls the volume of an audio signal; (ii) receiving, a request from the wireless device, with the request including information indicative that a user of the wireless device would prefer to have volume of the audio signal decreased; (iii) determining, by a machine logic negotiation, that the volume-control device should decrease the volume based on at least one of the following factors: (a) current volume level of the audio signal, (b) situation, (c) scheduling, (d) user patterns and/or (e) occasion; and/or (iv) responsive to the determination, sending a signal to a volume control module of the volume-control device, with the signal indicating that the volume control module is to lower the volume of the audio signal.

Some embodiments of the present invention may include one, or more, of the following features, characteristics and/or advantages: (i) assigning a first priority value to the wireless device; (ii) determining, by machine logic, that the first priority value exceeds a priority threshold; (iii) the request includes the first priority value; (iv) the determination that the volume-control device should decrease the volume is performed conditionally on condition that the first priority value exceeds the priority threshold; (v) assigning a second priority value to the volume control device; (vi) the priority threshold is based upon the second priority value; and/or (vii) the user of the wireless device is different than a primary user of the volume control device.

Some embodiments of the present invention may include one, or more, of the following features, characteristics and/or advantages: (i) using peer-to-peer device negotiation to arrive at a mutually acceptable volume level (as detected by the proximity of at least two devices); (ii) more specifically, using the negotiation aspects of the present invention (that is, where a device can determine that occasion, schedule, situation, user patterns, etc,) means that sometimes the users of the present invention will respect the request for a volume adjustment and other times the users will not; (iii) the device, and not necessarily the user, may request a volume adjustment from others and sometimes not, based on the negotiation aspects of the present invention mentioned above; and/or (iv) waits for a volume conflict to arise before conducting the negotiation.

Some embodiments of the present invention may include one, or more, of the following features, characteristics, advantages and/or operations: (i) machine logic to negotiate volume level of a sound-emitting device, where the negotiation is based, at least in part, upon the identities and/or attributes of a plurality of parties that desire different volume levels, and/or third parties present but not directly involved in the negotiation (for example, parent versus child, older person versus younger person, employer versus employee, sound device owner versus nearby stranger, law enforcement officer versus regular citizen, etc.); (ii) machine logic to negotiate volume level of a sound-emitting device, where the negotiation is based, at least in part, upon the occasional context (for example, birdwatching trip, at the beach, in a hotel, at a bus stop, at a trade show, at the site of an auto accident, etc.); (iii) machine logic to negotiate volume level of a sound-emitting device, where the negotiation is based, at least in part, upon the temporal/date context (for example, time of day, day of week, day of year, etc.); (iv) machine logic to negotiate volume level of a sound-emitting device, where the negotiation is based, at least in part, upon the user pattern context (for example, Joe meditates after he walks his dog, Mary typically listens to hard rock in the car on the way home from work before quiet time with her husband, etc.); (v) machine logic to negotiate volume level of a sound-emitting device, where the negotiation is based, at least in part, upon the device context (for example, the more expensive device is weighted more heavily in the negotiation, the device with the newer operating system is weighted more heavily in the negotiation, etc.); and/or (vi) peer-to-peer device negotiation to arrive at a mutually acceptable level as detected by the devices' proximity.

Some embodiments of the present invention may include one, or more, of the following features, characteristics, advantages and/or operations: uses at least the following input factors that affect the compromise solution: (i) ages of parties; (ii) income levels; (iii) job titles; (iv) biometrics (including heart rate, sleep data, etc.); (v) history of biometrics (for example, information indicating whether a user has or has not slept well in a given time period); (vi) doctor's advice (for example, it may be important for a user to avoid listening to loud music after ear surgery); (vii) parental controls; (viii) sentiment; (ix) time of day; (x) activity (including napping, exercising, bike riding, etc.); (xi) each user's crowd dynamics (for example: user A is in the company of friends, user B is with grandma, etc.); (xii) relationship between users A and B (such as friends, strangers, coworkers) being deduced from social media; (xiii) geographic location (such as via GPS, or deduced via calendar entries, such as “the user is at church on Sunday”); (xiv) location of origin (such as information indicating that the user grew up in Canada, in the mountains, the Midwestern part of the United States, etc.); (xv) data available in user health records (such as noise sensitivity); (xvi) personal values (such as political views, religious views, sensitivity to vulgarity); (xvii) upcoming events (such as an upcoming concert, getting ready for a meditation session, etc.); and/or (xviii) “ambient-location” acoustics (such as loud coffee shop or a library).

Some embodiments of the present invention may include one, or more, of the following features, characteristics, advantages and/or operations: uses subject matter upon which to compromise, including at least some of the following: (i) volume of party B device (such as user B's device B); (ii) radius of muting zone around user A's device; (iii) genre of music playlist (such as Christian music, jazz, no rap); (iv) topic of spoken playlist (such as the content of a blog or podcast subjects); (v) equalizer settings (such as bass, treble, etc.); (vi) output device (such as headphones, external speakers, phone, Bluetooth headset, etc.); and/or (vii) length of time for compromise (for example, setting the length of time for only 30 minutes, even if the two parties stay in close proximity, because this time setting gives time for the user to “do your thing and leave”).

Some embodiments of the present invention may include one, or more, of the following features, characteristics, advantages and/or operations: (i) uses peer-to-peer negotiation, which can include simple opt-in negotiation; (ii) individuals have preferences (for example, a doctor can refuse to be muted in order to receive emergency calls); (iii) system sends out a notice to all people who enter a given region (such as a church); (iv) participants whose preferences permit the request will mute all kinds of notifications to their network connected media devices (such as device A and device B); and/or (v) any participants' phones that receive calls will not ring (however, the doctor, by preferring not to be muted, is unaffected by the action and her phone will ring).

Some embodiments of the present invention may include one, or more, of the following features, characteristics, advantages and/or operations: (i) individuals have preferences (for example, a doctor agrees to lower her volume down to level 1 (where level 1 denotes the lowest volume level available) in the hospital if a patient with migraines so requests and wants no noise at all during nap times); (ii) individuals' phones monitor the situation independently (that is, the network connected media devices continuously check to see whether the migraine patient's preferences have changed); (iii) doctor listens to the latest medical podcast at level 6 while walking between her office and the cafeteria, passing through the hospital wing where patient is; (iv) patient's phone detects volume at level 6 from doctor's phone and broadcasts a request to mute the volume entirely; (v) doctor's phone receives the volume decrement request and responds that it can lower it to level 1, but that it cannot mute the volume entirely (that is, a “negotiation” is taking place); (vi) doctor's phone lowers to volume 1; and/or (vii) optionally, the patient's phone or doctor's phone can detect an exit from the region (that is, either phone detects that no further communication possible, so therefore the two phones must no longer be in same region) and as a result, the doctor's phone can raise back up to level 6 volume level.

Some embodiments of the present invention may include one, or more, of the following features, characteristics, advantages and/or operations: (i) establish a query system, where the devices explicitly negotiate a volume level adjustment in volume levels only when certain thresholds are exceeded; (ii) one device queries the other device for a volume level adjustment, and (based on user preference(s) and conditions) a volume level adjustment may or may not be made; (iii) a given device can determine that factors such as occasion, schedule, situation, user patterns, etc., mean that sometimes a given device will respect the request for a volume level adjustment and other times will not; and/or (iv) a given device may request a volume level adjustment from other device(s) and sometimes may not, based, at least in part, upon on the previously-mentioned aspects or factors.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Nuisance-causing characteristic: any output of a computer device that: (i) is perceivable by human senses, and (ii) causes or potentially causes human(s) in the vicinity of the output to be annoyed or bothered by the output; examples of nuisance-causing characteristics are sound and display brightness.

What is claimed is:

1. A computer-implemented method comprising:
receiving a set of request(s), respectively from a set of requesting device(s) respectively controlled by a set of requesting user(s), with each request of the set of request(s) including information indicative of a desire that a nuisance-causing characteristic of a target device, controlled by a target user, be decreased by respective requested amounts of decrease;
receiving a contextual data set including information of a set of attribute(s) relating to a context in which the target device is exhibiting the nuisance-causing characteristic;
responsive to the receipt of the set of request(s), applying a set of machine logic based rules to determine a negotiated compromise amount of decrease based upon the contextual data set, where the amount of decrease is: (i) greater than zero, and (ii) less than at least some of the request amount(s) of decrease; and
decreasing, by machine logic, the nuisance-causing characteristic of the target device by negotiated compromise amount of decrease.

2. The method of claim 1 wherein the nuisance-causing characteristic includes at least one of the following characteristics: sound volume, screen brightness and/or degree of suitability of content for children and/or adolescents.

3. The method of claim 1 wherein:
the set of request(s) includes only one request;
the one request includes a corresponding requested amount of decrease such that the nuisance-causing characteristic is turned off entirely; and
the decreasing of the nuisance-causing characteristic by the negotiated amount of decrease does not cause the nuisance causing characteristic to be turned off entirely.

4. The method of claim 1 wherein the contextual data includes data relating to at least one of the following categories of attributes: attributes of the set of requesting user(s), attributes of the target user, attributes of people in vicinity of the target device other than the target user and the requesting user(s), locational attributes, attributes of activities taking place in vicinity of the target device, attributes of content being presented by the target device, and/or time related attributes.

5. The method of claim 1 wherein the contextual data includes data relating to all of the following categories of attributes: attributes of the set of requesting user(s), attributes of the target user, attributes of people in vicinity of the target device other than the target user and the requesting user(s), locational attributes, attributes of activities taking place in vicinity of the target device, attributes of content being presented by the target device and time related attributes.

6. The method of claim 1 wherein a first request of the set of request(s) is generated automatically by machine logic of a first requesting device of the set of requesting device(s).

7. The method of claim 1 wherein a first request of the set of requests is generated manually by a first user and through a first requesting device of the set of requesting device(s).

8. A computer program product comprising:
a machine readable storage device; and
computer code stored on the machine readable storage device, with the computer code including instructions for causing a processor(s) set to perform operations including the following:
receiving a set of request(s), respectively from a set of requesting device(s) respectively controlled by a set of requesting user(s), with each request of the set of request(s) including information indicative of a desire that a nuisance-causing characteristic of a target device, controlled by a target user, be decreased by respective requested amounts of decrease,
receiving a contextual data set including information of a set of attribute(s) relating to a context in which the target device is exhibiting the nuisance-causing characteristic,
responsive to the receipt of the set of request(s), applying a set of machine logic based rules to determine a negotiated compromise amount of decrease based upon the contextual data set, where the amount of decrease is: (i) greater than zero, and (ii) less than at least some of the request amount(s) of decrease, and
decreasing, by machine logic, the nuisance-causing characteristic of the target device by negotiated compromise amount of decrease.

9. The product of claim 8 wherein the nuisance-causing characteristic includes at least one of the following characteristics: sound volume, screen brightness and/or degree of suitability of content for children and/or adolescents.

10. The product of claim 8 wherein:
the set of request(s) includes only one request;
the one request includes a corresponding requested amount of decrease such that the nuisance-causing characteristic is turned off entirely; and
the decreasing of the nuisance-causing characteristic by the negotiated amount of decrease does not cause the nuisance causing characteristic to be turned off entirely.

11. The product of claim 8 wherein the contextual data includes data relating to at least one of the following categories of attributes: attributes of the set of requesting user(s), attributes of the target user, attributes of people in vicinity of the target device other than the target user and the requesting user(s), locational attributes, attributes of activities taking place in vicinity of the target device, attributes of content being presented by the target device, and/or time related attributes.

12. The product of claim 8 wherein the contextual data includes data relating to all of the following categories of attributes: attributes of the set of requesting user(s), attributes of the target user, attributes of people in vicinity of the target device other than the target user and the requesting user(s), locational attributes, attributes of activities taking place in vicinity of the target device, attributes of content being presented by the target device and time related attributes.

13. The product of claim 8 wherein a first request of the set of request(s) is generated automatically by machine logic of a first requesting device of the set of requesting device(s).

14. The product of claim 8 wherein a first request of the set of requests is generated manually by a first user and through a first requesting device of the set of requesting device(s).

15. A computer system comprising:
a processor(s) set;
a machine readable storage device; and
computer code stored on the machine readable storage device, with the computer code including instructions for causing a processor(s) set to perform operations including the following:
receiving a set of request(s), respectively from a set of requesting device(s) respectively controlled by a set of requesting user(s), with each request of the set of request(s) including information indicative of a desire that a nuisance-causing characteristic of a target device, controlled by a target user, be decreased by respective requested amounts of decrease,
receiving a contextual data set including information of a set of attribute(s) relating to a context in which the target device is exhibiting the nuisance-causing characteristic,
responsive to the receipt of the set of request(s), applying a set of machine logic based rules to determine a negotiated compromise amount of decrease based upon the contextual data set, where the amount of decrease is: (i) greater than zero, and (ii) less than at least some of the request amount(s) of decrease, and
decreasing, by machine logic, the nuisance-causing characteristic of the target device by negotiated compromise amount of decrease.

16. The system of claim 15 wherein the nuisance-causing characteristic includes at least one of the following characteristics: sound volume, screen brightness and/or degree of suitability of content for children and/or adolescents.

17. The system of claim 15 wherein:
the set of request(s) includes only one request;
the one request includes a corresponding requested amount of decrease such that the nuisance-causing characteristic is turned off entirely; and
the decreasing of the nuisance-causing characteristic by the negotiated amount of decrease does not cause the nuisance causing characteristic to be turned off entirely.

18. The system of claim 15 wherein the contextual data includes data relating to at least one of the following categories of attributes: attributes of the set of requesting user(s), attributes of the target user, attributes of people in vicinity of the target device other than the target user and the requesting user(s), locational attributes, attributes of activities taking place in vicinity of the target device, attributes of content being presented by the target device, and/or time related attributes.

19. The system of claim 15 wherein the contextual data includes data relating to all of the following categories of attributes: attributes of the set of requesting user(s), attributes of the target user, attributes of people in vicinity of the target device other than the target user and the requesting user(s), locational attributes, attributes of activities taking place in vicinity of the target device, attributes of content being presented by the target device and time related attributes.

20. The system of claim 15 wherein a first request of the set of request(s) is generated automatically by machine logic of a first requesting device of the set of requesting device(s).
